(19) United States
(12) Patent Application Publication
(10) Pub. No.: US 2011/0298912 A1
(43) Pub. Date: Dec. 8, 2011

(54) WAVEFRONT SENSING FOR BIOMETRIC IMAGING

(75) Inventors: Jan Jelinek, Plymouth, MN (US); Kendall Lee Belsley, Falls Church, VA (US)

(73) Assignee: HONEYWELL INTERNATIONAL INC., Morristown, NJ (US)

(21) Appl. No.: 12/792,498

(22) Filed: Jun. 2, 2010

(51) Int. Cl. H04N 7/18; G01B 11/02

(52) U.S. Cl. 348/78; 356/121; 348/77; 348/E07.085

(57) ABSTRACT

Devices and approaches for addressing wavefront corruption in biometric applications. A biometric imaging system may have a laser, a wavefront sensor, and an optical system. The laser may be configured to project a laser spot onto a skin portion of a human face, and the optical system may be configured to collect scattered light from the laser spot and relay the light to the wavefront sensor. The biometric imaging system may also have an adaptive optical element and a controller configured to provide actuation commands to the adaptive optical element based at least in part upon a wavefront distortion measurement output from the wavefront sensor. The optical system may further be configured to relay image light to an image camera of the optical system. The image camera may be an iris camera configured for obtaining iris images suitable for biometric identification.

### GOVERNMENT RIGHTS

The U.S. Government may have certain rights in the present invention.

### TECHNICAL FIELD

The disclosure pertains generally to cameras and relates more particularly to cameras and camera systems that are configured for biometric imaging.

### BACKGROUND

In some applications, it may be desirable to identify individuals from a distance, perhaps with the individual unaware that they are being watched or identified. A number of biometric schemes exist for machine-based identification of humans using imaging. One way of identifying people is by imaging their eyes, or at least the iris portion of their eyes. Some approaches may rely on other facial features. Effective biometric identification may depend on very high quality imaging under less than ideal conditions.

In some situations, characteristics of the portion of the atmosphere through which light travels from object to camera can degrade image quality to a degree that biometric identification is compromised. For example, variations in refractive index can result in blurred images despite the use of otherwise focused optics. It would be desirable to have approaches and devices for biometric imaging that can compensate for such index variations.

### SUMMARY

The disclosure pertains generally to cameras and relates more particularly to cameras and camera systems that are configured for biometric imaging.

In some instances, a laser projected onto a human face may provide a reference for wavefront aberration measurements. In an illustrative but non-limiting example, the present disclosure provides a biometric imaging system that may include a laser, a wavefront sensor, and an optical system. The laser may be configured to project a laser spot onto a skin portion of a human face, and the optical system may be configured to collect scattered light from the laser spot and relay the light to the wavefront sensor. The biometric imaging system may also include an adaptive optical element and a controller configured to provide actuation commands to the adaptive optical element based at least in part upon a wavefront distortion measurement output from the wavefront sensor. The optical system may further be configured to relay image light to an image camera of the optical system. The image camera may be an iris camera configured for obtaining iris images suitable for biometric identification.

In another illustrative but non-limiting example, the present disclosure provides an approach for addressing wavefront corruption in biometric applications. The approach may include projecting a laser spot onto a skin portion of a human face, collecting a scattered light from the laser spot with an optical system, providing at least a portion of the scattered light to a wavefront sensor, and measuring a wavefront distortion with the wavefront sensor.

The above summary is not intended to describe each disclosed example or every implementation of the present disclosure. The Figures, Detailed Description and Examples which follow more particularly exemplify these implementations.

### BRIEF DESCRIPTION OF THE DRAWING

The following description should be read with reference to the drawings. The drawings, which are not necessarily to scale, depict selected illustrative examples and are not intended to limit the scope of the disclosure. The disclosure may be more completely understood in consideration of the following description of various illustrative examples in connection with the accompanying drawings, in which:

FIG. 1 is a schematic diagram showing an illustrative biometric imaging system configured to image a person of interest;

FIGS. 2a and 2b are schematic diagrams illustrating aspects of the operation of a Shack-Hartmann wavefront sensor; and

FIG. 3 is a schematic diagram showing an illustrative example of another biometric imaging system configured to image a person of interest.

### DETAILED DESCRIPTION

The following description should be read with reference to the drawings, in which like elements in different drawings are numbered in like fashion. The drawings, which are not necessarily to scale, depict selected examples and are not intended to limit the scope of the disclosure. Although examples of construction, dimensions, and materials are illustrated for the various elements, those skilled in the art will recognize that many of the examples provided have suitable alternatives that may be utilized.

When images are taken over larger distances, inhomogeneities in the medium through which light waves propagate from object to camera (e.g., the atmosphere) may corrupt, aberrate, or distort the wavefronts of the light waves. This phenomenon, sometimes informally referred-to as “shimmer,” may be particularly pronounced in outdoor environments. Laypersons may be familiar with strong instances of the effect when looking across, for example, a hot roadway surface. High resolution imaging, as may be required for identification at a distance, may be more susceptible to degradation from corrupted wavefronts than less demanding imaging tasks. Images of irises and some other biometric features like eye retinas, skin pores, etc., may require such a high level of detail discernibility that wavefront distortions from atmospheric inhomogeneities may become a problem at distances as short as about 10 meters, even though such distortions are not usually noticeable with the naked eye.

Empirically, the atmosphere is observed to include turbulence cells, or “turbules,” of varying refractive index, with the cells having a size distribution that varies depending on atmospheric conditions. The characteristic size of these cells is described by the so-called Fried parameter, r₀. The cells move around with the air mass, due to wind, convection, etc., with a characteristic time parameter t₀. To a fair approximation, wavefront distortion may degrade images taken with optical systems having apertures greater than r₀ and/or over exposure times greater than t₀. Biometric imaging approaches may often call for apertures and/or exposure times that exceed these measures, possibly by orders of magnitude.

A number of techniques for correcting distorted wavefronts are possible, involving actuatable or adaptive optical elements. To rectify the distorted wavefronts, these techniques may generally involve first measuring the aberrations. Approaches have been developed for that purpose, primarily in astronomy and laser weapons design. They generally call for a bright point source of light in the near vicinity of the object being observed to serve as a reference so that its light is likely to be passing through the same turbules of the atmosphere as is the light from the object of interest. A wavefront sensor may be mounted next to an image camera and aligned with its optical axis parallel to that of the camera so that both devices look in the same direction, with the sensor looking at the point source and the camera at the object of interest. To facilitate effective correction, a wavefront sensor may need to measure variations in wavefront distortion at a rate similar to that with which the distortions vary, i.e., on a time scale on the order of time parameter t₀, which may be orders of magnitude shorter than the exposure duration for the image camera. If, as may be in a typical arrangement, both the wavefront sensor and the camera share the main optics and their internal sensors are of comparable sensitivity, shortening the exposure of the wavefront sensor may be compensated for by increasing the brightness of its point source object by the same factor. In astronomy, the brighter point source is either a bright star that happens to be near the astronomical object of interest, or a so-called artificial star. The latter is not a real star, but a small cloud of naturally-occurring sodium atoms in the Earth's ionosphere that fluoresce brightly when excited by a sodium laser mounted on the telescope, making the cloud appear as a virtual star.

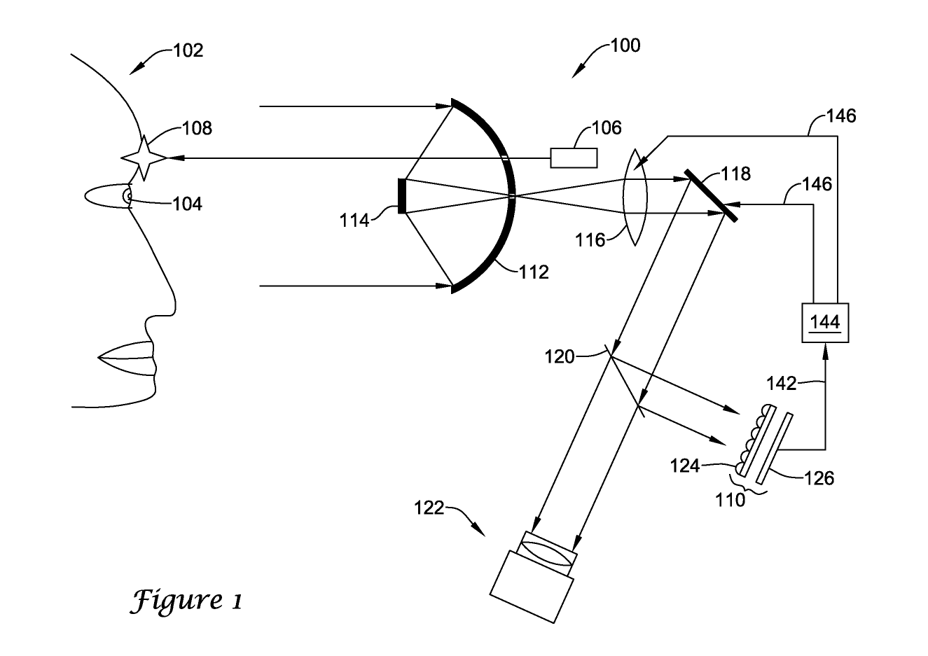

In the present disclosure, for biometric imaging applications, a bright point source for wavefront sensor aberration measurements may be provided by a laser beam projected onto the face of the individual being imaged. FIG. 1 is a schematic diagram showing an illustrative biometric imaging system 100 configured to image a person of interest 102. System 100 is shown configured to image an iris 104 of person 102, but it or other illustrative examples incorporating features of system 100 may be configured to image other biometric features. Biometric imaging system 100 may include a laser 106 configured to project a laser spot 108 onto the face of person 102. System 100 may be configured to project the laser spot 108 onto any suitable part of the face of person 102, and in particular, may be configured to project the spot onto a skin portion of the face. Spot 108 may be projected on the forehead of person 102, as illustrated, or onto a cheek. In some illustrative examples, a laser spot may be projected onto an eye of a subject. However, for a variety of reasons, projecting laser spot 108 onto a skin portion of person 102 may provide certain advantages, such as greater reflectance, potentially easier aiming, eye safety, and lower noticeability. In some scenarios, spot 108 may be projected onto any suitable non-body surface proximal the iris 104 or other biometric feature to be imaged, such as an article of clothing or other body covering such as a respirator mask.

Laser 106 may be an infrared laser with a wavelength invisible to human sight. Any suitable laser technology may be used. Laser 106 may produce light with a wavelength of about 1550 nm, though any suitable wavelength may be employed. Laser 106 may produce light considered eye-safe, in terms of parameters such as (but not limited to) wavelength, power, brightness, spot size, intensity, irradiance, and so on. In some illustrative examples, the laser 106 may be used to perform tasks in addition to providing a bright point source for wavefront aberration measurements. For example, the laser 106 may be used to perform ranging, motion tracking (including measuring eye motion within the socket), and other biometric functions, such as three-dimensional and two-dimensional facial recognition. It may be possible for some of these tasks to be performed simultaneously with wavefront aberration measurements, while some of the tasks may be performed separated in time from wavefront aberration measurements. In some illustrative examples, laser 106 may be provided in a three dimensional LIDAR imaging device provided by, for instance, Digital Signal Corporation of Alexandria, Va.

The biometric imaging system 100 may include an optical system configured to collect scattered light from the laser spot and relay the light to a wavefront sensor 110. The optical system illustrated in FIG. 1 includes a primary mirror 112 and a secondary mirror 114 configured essentially as a reflector telescope, but this is not necessary. For example, some illustrative examples may include refractive (rather than reflective) optical elements for light gathering that may be configured as a zoom or a fixed-focal length lens system. Any suitable optical components may be included in the optical system, such as lens 116, mirror 118, beam splitter 120, polarizers (not shown), filters (not shown), and so on. Either or both of lens 116 and mirror 118 may be adaptive optical elements, as discussed further herein, capable of providing corrections to distorted wavefronts, at least in part. Biometric imaging system 100 may include other adaptive optical elements as well.

Beam splitter 120 of the optical system may be configured to provide light from the individual or scene being imaged to the wavefront sensor 110 and image camera 122, which may be an iris camera. An iris camera is a camera configured for obtaining iris images suitable for biometric identification. The image camera 122 may be sensitive to infrared light, although its spectral sensitivity may vary with regard to that of the wavefront sensor 110 and the emission wavelength of the laser 106. The optical system of biometric imaging system 100 may be configured such that scattered light from the laser spot 108 and image light scattered from the iris 104 (or whatever features are being imaged by the image camera) travel similar or overlapping optical paths as they are relayed to the wavefront sensor 110 and image camera 122, respectively. A high degree of overlap of these optical paths generally may increase the degree by which the wavefronts reaching the wavefront sensor 100 and image camera 122 are similarly aberrated, enhancing the probability that corrections to the wavefronts based upon measurements taken with the wavefront sensor will result in improved imaging at the image camera, compared to an arrangement with less overlap of optical paths. Projecting the laser spot 108 in close proximity to the iris 104 (or other feature(s) being imaged) may also tend to enhance the degree of overlap of the optical paths. In some illustrative examples, system 100 may be configured to project the laser spot 108 within 50, 40, 30, 20, or 10 millimeters of iris 104. In some illustrative examples, a laser spot 108 and an iris 104 (or other imaging target) are disposed within an isoplanatic angle as referenced relative to the biometric imaging system.

In some illustrative examples, the outgoing laser beam from the laser 106 to the laser spot 108 may travel a path substantially parallel to the optic axis of the system 100. This may result in the distance and location of the laser spot 108 relative to the iris 104 remaining substantially the same irrespective of the distance of the person of interest 102 from the optical system 100. In some illustrative examples, outgoing laser light may follow an optical path propagating at least in part through optical elements of the optical system, such as secondary and primary mirrors 114, 112. In other illustrative examples, the outgoing laser beam may be projected from a position proximal to the elements of the optical system, but may not optically propagate through those elements. Such a case is illustrated in FIG. 1, where the laser 106 is positioned to project its beam through a hole in primary mirror 112 toward laser spot 108. This may allow the laser beam to travel close to the optical axis of the optical system, without the beam being affected optically by elements of the optical system. In some illustrative examples, the laser beam may not be parallel to the optical axis of the optical system but may cross it.

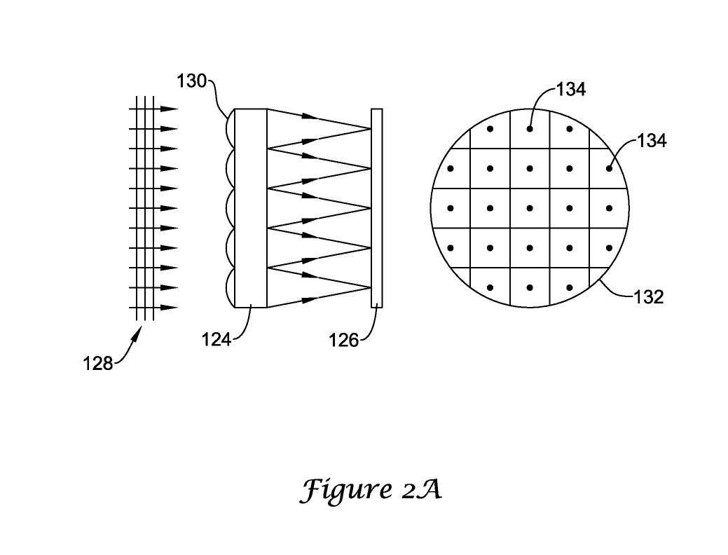

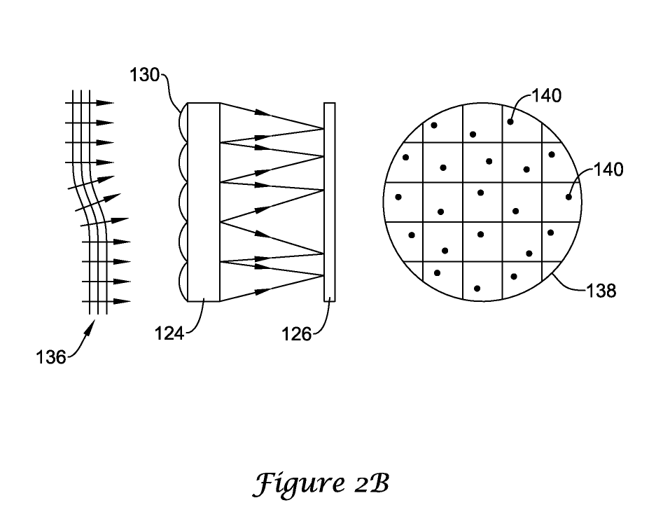

Wavefront sensor 110 may be any suitable wavefront sensor. As schematically illustrated in FIG. 1, it may be a Shack-Hartmann wavefront sensor having a microlens array 124 and a focal plane sensor array 126. FIGS. 2a and 2b are schematic diagrams illustrating aspects of the operation of a Shack-Hartmann wavefront sensor. In FIG. 2a, uncorrupted planar wavefronts 128 are incident upon the microlens array 124. The individual lenslets 130 of the array 124 focus the light onto the focal plane sensor array 126 in a regularly-spaced pattern, as represented in the plan view 132 of the array, with lenslets essential focusing the incident light to points 134 coincident with their focal points. In FIG. 2b, corrupted, aberrated, or distorted wavefronts 136 are incident upon the microlens array 124. The individual lenslets 130 of the array 124 focus the light onto the focal plane sensor array 126 in an irregularly-spaced pattern, as represented in the plan view 138 of the array, with lenslets focusing the incident light to irregularly-spaced points 140 depending at least in part upon the distortion of the wavefront at the corresponding lenslet.

The focal plane sensor array 126 may be any suitable sensor array. A suitable sensor array may possess sufficiently high sensitivity to the wavelength of light of laser 106, sufficiently high resolution for measuring the positions of the focused points 134, 140, and a sufficiently fast frame rate for following temporal changes in wavefront distortion. Possible sensor arrays that may be suitable as focal plane sensor array 126 are the “Triwave” germanium-enhanced CMOS device from NoblePeak Vision Corporation of Wakefield, Mass,, and the XEVA SHS and the CHEETA 400, both made by XenICs of Leuven, Belgium.

Wavefront sensor 110 may communicate a wavefront distortion measurement output 142 to controller 144 as schematically represented in FIG. 1. Wavefront distortion measurement output 142 may be in any suitable form. In some illustrative examples, output 142 may be an analog or digital video signal. Controller 144 may process, with any suitable approach, the information in output 142 to characterize distortions of wavefronts incident upon the wavefront sensor 110. In some illustrative examples, wavefront sensor 110 may process information from focal plane sensor array 126 to characterize distortions of incident wavefronts, and provide processed distortion characterizations as wavefront distortion measurement output 142 to controller 144. Controller 144 may be configured to provide actuation commands 146 to one or more adaptive optical elements of biometric imaging system 100, such as lens 116 and/or mirror 118, based at least in part upon the wavefront distortion measurement output 142. In some illustrative examples, actuation commands 146 may be provided at rates ranging from tens to hundreds of corrections per second.

Any suitable adaptive optical elements or components may be used in biometric imaging system 100. An adaptive optical element of system 100 may be capable of providing tip/tilt corrections, which may affect a wavefront globally, for example, providing a global modification to the angle of propagation of a wavefront. Such a correction may essentially result in correction of side-to-side and/or up-down displacement of an image (resulting from atmospherically-induced wavefront distortions) on an image sensor of image camera 122 and focal plane sensor array 126. Adaptive optical elements capable of imparting higher order corrections to wavefronts may be employed as well, such as deformable mirrors. Mirror 118 may be either a tip/tilt mirror or a deformable mirror, or both. In some illustrative examples, separate tip-tilt and adaptive mirrors may be used to correct global and local wavefront aberrations, respectively, or other suitable combinations of adaptive optical elements may be provided to achieve similar outcomes.

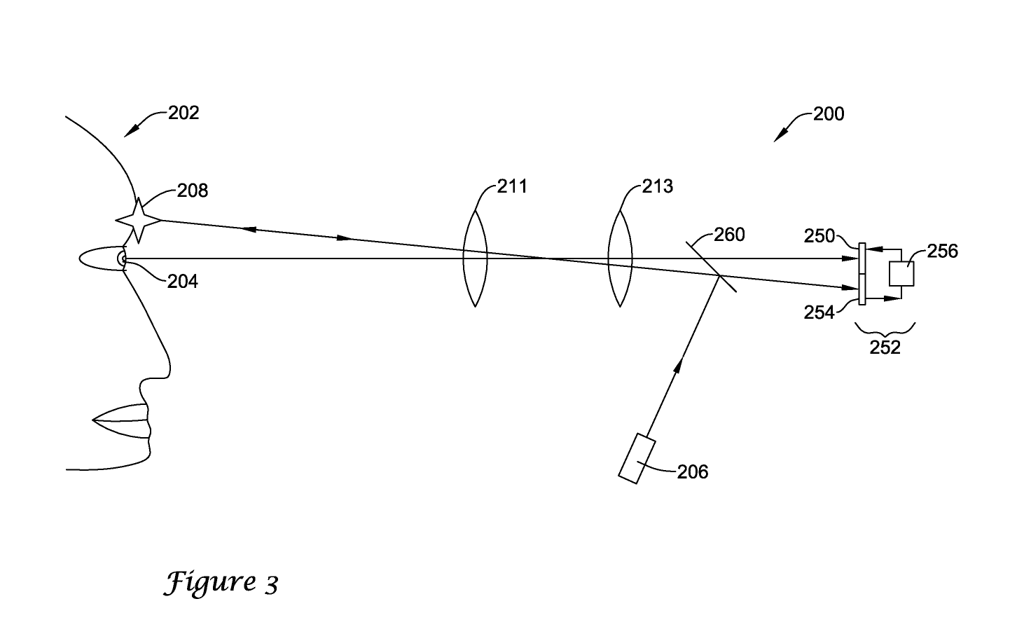

FIG. 3 is a schematic diagram showing illustrative example of another biometric imaging system 200 configured to image a person of interest 202. System 200 is shown configured to image an iris 204 of person 202, but it may be configured to image other biometric features. Biometric imaging system 200 may include a laser 206 configured to project a laser spot 208 onto the face of person 202. Biometric imaging system 200 may include an optical system configured to collect scattered light from the laser spot 208 and iris 204. The optical system may include refractive optical elements, such as schematically illustrated primary lens 211 and secondary lens 113. The optical system of biometric imaging system 200 may be configured to relay image light (including light scattered from iris 204) to an image field 250 of an Orthogonal Transfer CCD (OT CDD) array sensor 252, and light scattered from laser spot 208 to a guide field 254 of the OT CCD array sensor. OT CCD array sensors have been developed by MIT Lincoln Laboratories of Lexington, Mass. As the image of the laser spot 208 varies in location on the guide field 254 due to wavefront distortions, a charge motion controller 256 of the OT CCD array sensor 252 may electronically shift the location of pixels in the image field 250 to compensate, based upon a wavefront distortion measurement output from guide field 254. In system 200, guide field 254 may be considered a wavefront sensor, and image field 250 may be considered an adaptive optical element. Other adaptive optical elements may be included in biometric imaging system 200 as part of the optical system. OT CCD array sensor 252 may be considered part of an image camera of biometric imaging system 200. In system 200, the beam from laser 206 projecting the laser spot 208 is shown entering the optical system via a beam splitter 260. The beam then propagates through lenses 213 and 211 toward the face of the person 202. However, it is not necessary to propagate the laser beam through the optical system in this manner, and other configurations are possible.

In some illustrative examples, an OT CCD array sensor may include an image field (such as field 250) for biometric image acquisition, but not a guide field (such as field 254). In the absence of a guide field, a wavefront distortion measurement may be provided by or derived from the output of a wavefront sensor separate from the OT CCD array sensor. The output of such a wavefront sensor may be used as input to a charge motion controller (such as controller 256) and possibly for other controllers for adaptive optical elements such as adaptive mirrors as well, if such elements are used in conjunction with the OT CCD array sensor.

Approaches of addressing wavefront aberrations in biometric applications are contemplated in the present disclosure, employing biometric imaging systems such as system 100, 200 or other suitable systems. In an illustrative approach, a laser spot may be projected onto a skin portion of a human face, which may be a forehead or a cheek of the face. Light scattered from the laser spot may be collected by an optical system. At least a portion of the scattered light may be provided to a wavefront sensor, with which a wavefront distortion may be measured. The approach may further include controlling an adaptive optical element based at least in part upon a wavefront distortion measurement performed with the wavefront sensor. An image of an iris or other biometric feature(s) suitable for biometric identification may be captured with an image/iris camera. This image may be improved as a result of the control of the adaptive optical element, compared to the case of an image taken without control of the adaptive optical element based at least in part upon the wavefront distortion measurement performed with the wavefront sensor.

The disclosure should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

What is claimed is:

1. A biometric imaging system, comprising:
a laser configured to project a laser spot onto a skin portion of a human face;
a wavefront sensor;
an optical system configured to collect scattered light from the laser spot and relay the light to the wavefront sensor.

2. The biometric system of claim 1, further comprising an image camera, wherein the optical system is configured to relay image light to the image camera.

3. The biometric system of claim 2, wherein the image camera is an iris camera, and the image light comprises light scattered from an iris of the human face onto which the laser spot is projected.

4. The biometric system of claim 2, wherein the image camera comprises an orthogonal transfer CCD array sensor.

5. The biometric system of claim 1, wherein the optical system comprises an adaptive optical element.

6. The biometric system of claim 5, wherein the adaptive optical element is a mirror.

7. The biometric system of claim 5, wherein the adaptive optical element is a lens.

8. The biometric system of claim 5, wherein the adaptive optical element is capable of providing tip/tilt corrections.

9. The biometric system of claim 4, further comprising a controller configured to provide actuation commands to the adaptive optical element based at least in part upon a wavefront distortion measurement output from the wavefront sensor.

10. The biometric system of claim 1, wherein the wavefront sensor comprises a microlens array and a focal plane sensor array.

11. The biometric system of claim 1, wherein the laser is an infrared laser.

12. The biometric system of claim 11, wherein the laser provides laser light at about 1550 nm.

13. The biometric system of claim 1, wherein the laser is configured to perform a ranging measurement.

14. An iris imaging system, comprising:
an infrared laser configured to project a laser spot onto a skin portion of a human face;
a wavefront sensor;
an iris camera;
an optical system configured to collect scattered light from the laser spot and relay the light to the wavefront sensor, the optical system further configured to relay image light to the iris camera from an iris of the human face onto which the laser spot is projected; and
at least one adaptive optical element incorporated into at least one of the optical system and the iris camera;
wherein the at least one adaptive optical element is controlled to correct, at least in part, wavefront distortions measured with the wavefront sensor.

15. The iris imaging system of claim 14, wherein the at least one adaptive optical element is configured to perform tip/tilt corrections.

16. The iris imaging system of claim 14, wherein the at least one adaptive optical element is configured to perform higher-order corrections, compared to tip/tilt corrections.

17. The iris imaging system of claim 14, wherein the infrared laser is configured to perform at least one function related to biometric iris imaging in addition to projecting the laser spot.

18. A method for addressing wavefront corruption in biometric applications, comprising:
projecting a laser spot onto a skin portion of a human face;
collecting a scattered light from the laser spot with an optical system;
providing at least a portion of the scattered light to a wavefront sensor; and
measuring a wavefront distortion with the wavefront sensor.

19. The method of claim 18, further comprising the step of controlling an adaptive optical element based at least in part upon a wavefront distortion measurement performed in the measuring step.

20. The method of claim 18, further comprising the step of capturing an iris image suitable for biometric identification with an iris camera.
